(19) United States
(12) Patent Application Publication
(10) Pub. No.: US 2005/0162551 A1
(43) Pub. Date: Jul. 28, 2005

(54) Multi-lingual closed-captioning

(75) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/507,995

(22) PCT Filed: Feb. 17, 2003
(86) PCT No.: PCT/IB03/00593

(30) Foreign Application Priority Data
Mar. 21, 2002 (EP) 02076107.8

(51) Int. Cl. H04N 11/00

(52) U.S. Cl. 348/468; 348/465

(57) ABSTRACT

A terminal for a television broadcast system with multi-lingual closed captioning support comprises a television receiver and a decoder for decoding a closed-captioning information stream. The terminal is programmed to continuously form data elements from the embedded closed-captioning information stream, each data element being unique to a closed-caption string. The terminal is connected to a network (29) comprising a translation service server (30), and is programmed to send the data elements with a specification of a desired caption language to the translation service server, and to receive captions in the desired language.

### FIELD OF THE INVENTION

The invention relates to a terminal for a television broadcast system with multi-lingual closed captioning support, comprising a television receiver, a decoder for decoding an embedded closed-captioning information stream, which terminal is programmed to continuously form data elements from the embedded closed-captioning information stream, each data element being unique to a closed-caption string.

The invention further relates to a television broadcast system with multi-lingual closed-captioning support.

### BACKGROUND OF THE INVENTION

An example of a terminal as described in the opening paragraph is known. The abstract of TW-A-303 568 discloses a method that involves receiving a television signal containing caption data and fetching caption data from the television signal to form a referenced image signal and a caption data signal. An input instruction is received with respect to selected caption data and the selected caption data is stored. Text meaning and/or translation data corresponding to the selected caption data stored in memory is fetched, displayed on the screen, and the selected caption data is translated and explained.

The known terminal has a number of drawbacks. Because a translation of the stored captions takes place on the terminal, the terminal must be provided with the appropriate dictionary and translation software. To make the terminal suitable for several languages requires multiple dictionaries to be present. These must be stored. Additionally, because the data elements formed from the closed-captioning stream, i.e. the caption data signal itself, is stored first, captions for a program only become available in the desired language after the program has been broadcast.

### OBJECT AND SUMMARY OF THE INVENTION

It is an object of the invention to provide an improved terminal of the type mentioned in the pre-amble of claim 1, which allows multi-lingual closed captioning support in any of a large number of possible languages.

This object is achieved by the terminal according to the invention, which is characterised in that the terminal further comprises a bidirectional network interface for connection to a network comprising a translation service server, and is programmed to send the data elements with a specification of a desired caption language to the translation service server, and to receive captions in the desired language from the translation service server.

Using such an architecture, the translated captions can be provided externally, namely by the translation service server. Thus, any number of translation service servers can be used, each providing support for a different language, or one powerful server can be used that provides support for a large number of languages. Extensive changes or downloads are not required when support for a further language is to be provided, or when account needs to be taken of evolutions in an existing language.

Preferably, the terminal is further programmed to establish an end-to-end connection to the translation service server through which it re-directs the formed data elements and receives the captions in the desired language.

Thus, continuous support can be provided whilst a program is being broadcast. It is not necessary to store an entire program received through the broadcast channel until such time as the captions in the desired language are made available to the terminal.

In a preferred embodiment of the invention, the terminal is programmed to include at least one return address, specifying a caption receiving terminal with the formed data elements.

Thus, the captions in the desired language can be made available on a different terminal as well as or instead of the terminal sending the data elements. It becomes possible for viewers who do not have a language in common with which they are both familiar, to view a program together. One of them will receive the captions in a language desired by him on the caption-receiving terminal, this could be a computer or mobile phone with an Internet browser, for example. The other viewer can receive the captions in his language on the terminal for the television broadcast system.

According to a further aspect of the invention, a television broadcast system with multi-lingual closed-captioning support is provided, comprising at least one terminal according to any one of claims 1-8, which system further comprises a network to which the terminal is connected through its interface, the network comprising a translation service server on which translation software is installed for translating text strings received from the terminal into a desired langauage specified by the terminal, wherein the terminal is programmed to continuously form text strings from the embedded closed-captioning information stream and to re-direct the formed text strings through the network to the translation service server.

The system is particularly suited to using conventional translation software, through its use of strings. In particular, an Internet-based translation service can be part of the system. Such a service comprises large dictionaries and is configured for handling a large number of requests, such as would be made in a system comprising many terminals. In addition, such a translation service is usually free of charge.

According to another aspect of the invention, a television broadcast system with multi-lingual closed-captioning support is provided, comprising at least one terminal according to any one of claims 1-8, which system further comprises a network to which the terminal is connected through its interface, the network comprising a translation service server with a caption database with entries for a plurality of captions, each entry recording a caption identifier and at least one translation of a caption string, wherein the terminal is programmed to re-direct caption identifiers formed from the decoded closed-captioning information through the network to the translation service server.

Such a system can be advantageously used by broadcasters to provide multi-lingual closed-captioning support for a much wider range of languages than would be possible if the captions were all to be provided with the closed-captioning information stream embedded in the broadcast signal. The wide range of possible languages even allows the provision of closed captions in a plurality of regional dialects. Addition of an extra language or dialect merely requires an addition to the caption database.

### BRIEF DECRIPTION OF THE DRAWINGS

The invention will now be explained in further detail with reference to the accompanying drawings, of which

FIG. 1 is a schematic diagram for explaining embodiments of the broadcast systems according to the invention;

FIG. 2 shows a diagram of some key hardware components of a terminal according to the invention; and

FIG. 3 shows a basic architecture for embodiments of the terminal according to the invention.

### DESCRIPTION OF PREFERRED EMBODIMENTS

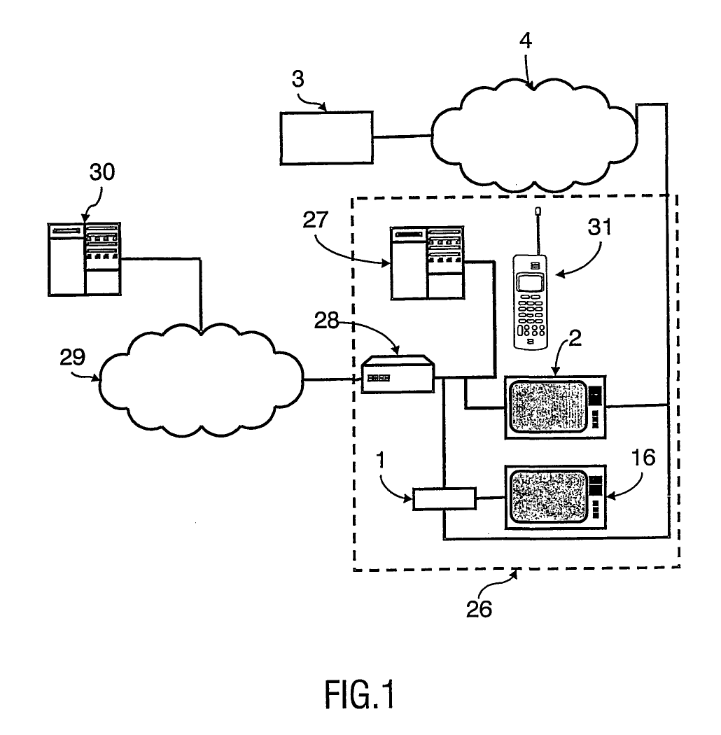

Two examples of terminals for use in connection with the invention are shown in FIG. 1. The first example is a set-top box 1, the second example an interactive digital television set IDTV 2). The terminal comprises a television receiver, for receiving broadcast information from a broadcaster 3 through a broadcast network 4. The broadcast network 4 can be a cable network, satellite network or terrestrial broadcast network. Broadcast information can be digital or analogue (e.g. PAL, NTSC, SECAM, DVB).

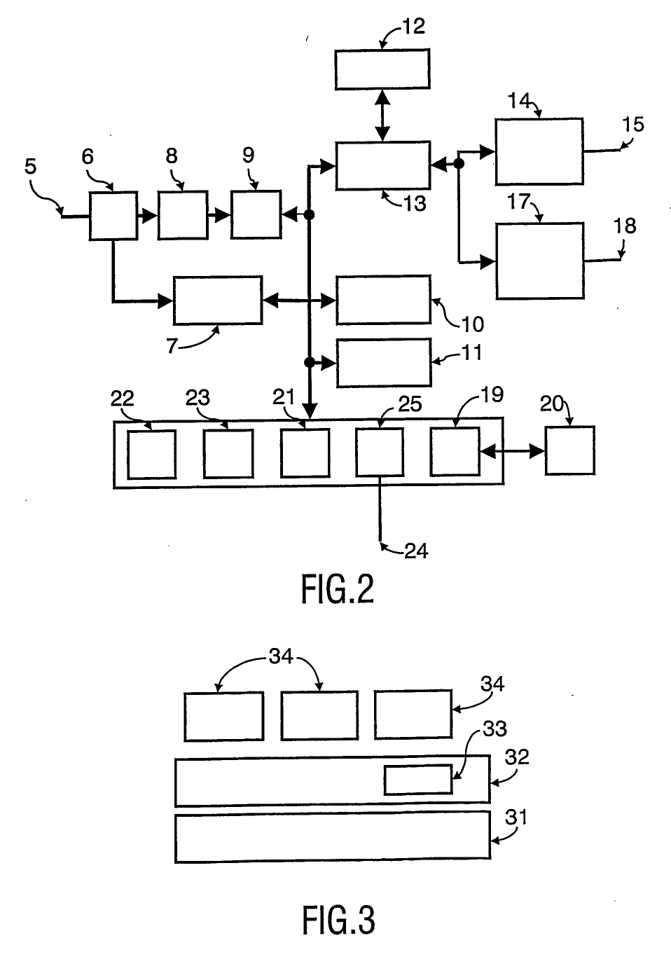

Turning to FIG. 2, the terminal comprises a broadcast channel connection 5 for connection to the broadcast network 4. The terminal comprises a tuner 6 for tuning in to a specific carrier frequency. In the example of FIG. 2, the terminal is capable of receiving analogue and/or digital broadcast streams. In the former case, the signal is passed from the tuner 6 to an analogue video processor 7. In the latter case, the signal is first de-modulated and de-multiplexed in a demodulator 8 and demultiplexer 9, respectively. Digital broadcasts are usually compressed, for example using the MPEG2-standard compression algorithm, so the terminal comprises an MPEG video decoder 10 for retrieving the broadcast data. The terminal further comprises a system processing unit 11 for processing broadcast and video data. System memory 12, connected to the processing unit 11 via a memory controller 13 and a bus, can be used to temporarily store the video and broadcast data. A display engine 14 outputs video data in a format suitable for displaying on a display connected through a video output channel 11. In the set-top box 1 there would be a digital video interface and/or an analogue interface to a conventional television 16 or a video recorder (not shown in FIG. 1) connected to the set-top box 1. Similarly, an audio engine 17 provides an audio signal through an audio output channel 18.

The processing unit 11 is also capable of decoding closed-captioning information streams that are embedded in the broadcast data received through the broadcast channel connection 5. Captions are text located somewhere in a video picture. Closed captions are captions that are hidden in the video signal, invisible without a decoder.

The exact way in which the closed-captioning information is embedded in the video signal received through the broadcast channel connection 5 depends on the broadcast standard. In analogue television broadcasts, closed captions are hidden in teletext pages, usually with page number 888. The teletext pages are broadcast in the virtual blanking interval in case of interlaced broadcasts. In digital television according to, for example, the Digital Video Broadcasting Standard, closed captioning information is broadcast as MPEG2-packets with the closed captioning information specifically identified as such.

The terminal according to the invention further comprises a bidirectional network interface. This means that it is capable of being connected to a network, through which it can both transmit and receive data. In other words, there is a second channel, a return channel, physically separate from the broadcast channel 5. Thus, the terminal could, for example, be compliant with the IB1 profile laid down in the Multimedia Home Platform specification for digital video broadcasting.

As an example of an implementation of the bidirectional network interface, the terminal illustrated in FIG. 2 comprises a PCI (Peripheral Component Interface)-controller 19, and an ethernet-card 20, connected to a PCI-bus. The terminal further comprises a USB (Universal Serial Bus)-controller 21. The skilled person will realise that a bi-directional network interface could also, for example, be realised by connecting an external modem or network card to a USB port or through the use of a PCI-modem.

The terminal of FIG. 2 further comprises an I2C-controller 22 and an EIDE-controller 23. A hard disk could be attached to the latter. The user can issue commands to the terminal through a remote control communications channel 24, using a remote control unit (not shown), for which purpose an IR-controller 25 is provided. It will be realised that the terminal will comprise further components, which are not relevant in the present context. The various components can be integrated to a higher or lesser degree in one or more integrated circuits in the terminal, or indeed be present as software modules, which can be run on the system processing unit 11, so as to provide the equivalent functionality.

For the purpose of explaining the invention, a viewer's home is indicated by a dashed line 26. The viewer has a home network at his disposal. Both the set-top box 1 and the IDTV 2 are connected to the home network, for example through the ethernet-card 20. Additionally, the home network comprises a server 27 and an Internet access router 28. The Internet access router 28 provides access to the Internet 29, which of course comprises multiple servers, an example being indicated by reference number 30.

Conventional closed-captioning services provide only limited multi-lingual support. The broadcaster 3 might occasionally provide closed-captioning information in a couple of languages with the broadcast signal. However, the number of languages is usually limited to a few important languages. To provide closed captions for a large number of languages as an embedded information stream would require a lot of bandwidth. Each terminal would receive all the different language versions, even though only one is required. Also, there is no incentive for the broadcaster 3 to provide closed-captioning support for a large number of languages. It would be much more efficient if the viewer were to be able to retrieve the captions in the desired language himself. The invention provides a terminal and system by means of which this can be achieved.

The terminal is programmed to continuously form data elements from the closed-captioning information stream received through the broadcast channel 5. As will be explained below, these data elements can comprise strings encoding caption text or identifiers identifying a caption text, or a combination. Because the terminal comprises a bi-directional network interface, it is able to send these data elements to a translation service server. The translation service server returns the captions in the desired language, which the terminal receives through its network interface.

The use of a translation service server has the advantage that third parties can provide captions in various languages, possibly charging for the service. The broadcaster 3 can make the captions available in a large number of languages, without using up the bandwidth allocated to him in the broadcast network 4.

According to one embodiment of the invention, the terminal is programmed to continuously form text strings from the embedded closed-captioning information stream and to re-direct the formed text strings to a translation service server. Translation software is installed on the translation service server for translating the text strings received from the terminal into the desired language specified by the terminal.

Both the server 27 in the home network and the server 30 in the Internet 29 can be used as translation service servers. The advantage of using the server 27 in the home network is that communication costs are reduced. It is an implementation of the invention that is well suited to those needing daily translation of broadcast material. The advantages of using a server 30 in the Internet 29, is that there are already a number of Internet-based translation services providing free translation. In addition, the number of languages supported can be easily increased. It is not necessary for the viewer to have translation software that supports many languages.

The desired language can be specified by the destination address to which the text strings are sent, or by adding a code to the text strings that the translation software is able to recognise. In the former case, a uniform resource locator (URL) could be used for each language.

It would be possible to provide a URL for each combination of source language—the language in which the text strings are provided to the translation service server—and desired language. The terminal would then need to have access to a list of addresses. Alternatively, especially in the home network, a standard language could be assumed, so that information regarding the source language need not be sent to the translation service server at all. However, to be able to provide a truly universal translation service from any language to any language, the terminal is preferably programmed to add a specification of a source language to the formed text strings re-directed to the translation service server. The embedded closed-captioning information stream provided through the broadcast network 4 can thus be in any language. It is conceivable that the specification of the source or destination language is provided implicitly, in that the server 30 is able to determine the geographical location of the terminal from a return address or from a network address revealed to it when an end-to-end connection is set up between it and the terminal. It is also conceivable that the source languages could be derived from an Electronic Program Guide (EPG) web service or similar service.

If the Internet-based server 30 is used as translation service server, an alternative embodiment of the invention is possible, which reduces the amount of data traffic. In this embodiment, the server 30 comprises a caption database with entries for a plurality of captions, each entry recording a caption identifier and at least one translation of a caption string. The terminal is programmed to re-direct caption identifiers formed from the decoded closed-captioning information through the Internet 29 to the server 30. Specification of the desired language by the terminal can be carried out in the same ways as in the embodiment in which text strings are re-directed to the translation service server.

The broadcaster 3 translates the captions into a number of languages and compiles the translated captions in a database hosted on the server 30. Because only caption identifiers are sent to the server 30, the amount of network traffic between the terminal and the server 30 is reduced. It is more advantageous for the broadcaster 3 to provide the translated captions in this way than as an embedded information stream through the broadcast network 4. The broadcaster 3 can use the, often limited, bandwidth of the broadcast network 4 for other purposes. He can charge separately for the service of providing translated captions, even differentiating between languages.

It would be conceivable to send the data elements formed by the terminal from the embedded closed-captioning stream as an electronic mail message to the server 30 in the Internet 29. However, the transmission protocols usually used for sending electronic mail make use of gateways that slow down the messages transferred from the terminal to the translation service server. Additionally, the terminal would have to use a mail fetching protocol to retrieve the returned captions in the desired language. It would be quite difficult for the terminal to synchronise the captions in the desired language with the video signal received through the broadcast channel 5. The terminal would have to buffer a large amount of video data until the captions in the desired language become available.

The terminal is therefore preferably programmed to establish an end-to-end connection to the translation service server through which it re-directs the formed data elements and receives the captions in the desired language. The HyperText Transfer Protocol running over the Transmission Control Protocol can, for example, be used to this end.

It is not necessary that the captions in the desired language be returned to the terminal that formed the data elements from the embedded closed-captioning information stream. In one embodiment of the invention, the terminal is programmed to include at least one return address specifying a caption-receiving terminal with the formed data elements. The caption-receiving terminal need not be a terminal such as the IDTV 2 or the set-top box 1. It need only be capable of receiving the captions in the desired language and making them available to the user. Generally, it need not be capable of receiving the broadcast data from the broadcaster 3. For example, FIG. 1 shows a mobile phone 31 with a web-browser, which can receive the captions in the desired language and display them. If, for example, two people are watching the IDTV 2 together, one can receive captions in one language on the mobile phone 31, whilst the other makes use of captions in a different language displayed on the IDTV 2. Another advantage of using a separate caption-receiving terminal is that it is possible to view the entire picture on the IDTV 2, without the captions getting in the way.

According to yet a further embodiment of the invention, the terminal comprises a speech synthesiser, capable of converting received captions in the desired language into an audio signal. This embodiment can be implemented in various ways. For example, where the translation service server comprises a caption database, some or all of the captions can be in an audio format. Alternatively, the terminal can have been provided with software to synthesise an audio signal from strings provided by the translation service server, which audio signal is made available through the audio output channel 18.

At least one embodiment of the terminal according to the invention comprises a display reformattor, capable of adding the received captions in the desired language to a television picture received by the television broadcast receiver. Although the foregoing description may have suggested that the captions in the desired language consist of character strings, this need not be the case. Indeed, character strings by themselves would not provide a very pleasant viewing experience, since they would be displayed in a default location in the picture with a default appearance.

Therefore, the terminal is preferably programmed to use meta-data provided with the received captions in the desired language to determine the appearance of the received captions. The meta-data can encode such parameters as the colour of the caption, its location in the picture, the length of time it is to be displayed, etc. It is conceivable that the captions are provided as strings with tagged on codes containing the meta-data. Alternatively, the captions in the desired language can be sent in the shape of picture files, encoding such things as colour. An example of a file-format that can be used in this connection is the Graphical Interchange Format (GIF).

Where use is made of a translation service server with a caption database, the meta-data can be included in the database, especially if the broadcaster 3 is responsible for the contents of the database. Where use is being made of a translation service server that comprises translation software, this would be more difficult. It would therefore be advantageous for the terminals to be programmed to add meta-data specifying the appearance of a caption to the formed data elements redirected to the translation service server. The terminal can use the closed-captioning information stream provided through the broadcast channel 5 for this purpose. Meta-data specifying the appearance of captions can be included with the closed-captioning text in nearly all the formats defined for broadcasting closed-captioning information. The terminal need only be programmed to extract this meta-data and add it to the text strings or caption identifiers that it sends to the translation service server. The terminal could also edit the meta-data before sending it to the translation service server. For example, it could use a colour mapping to alter the colours specified by the broadcast meta-data It could thus take account of the colour-blindness of a viewer, or of the background colour in the picture, for example.

As a further feature of the invention, the specification of a desired language sent by the terminal to the translation service server may include an identification of a subset of the desired caption language. For example, this feature could be used in combination with a parental guard function of the IDTV 2 or set-top box 1, to limit the exposure of children to rude or violent language. Where use is made of a caption database on the server 30, the database can comprise an adult and an under-age set of captions. Where use is made of translation software on one of the servers 27, 30, the software could use different subsets of a dictionary. This feature could also be used to take account of regional language differences and local dialects. The broadcaster 3 can provide a caption database on the server 30 comprising captions in many different regional variants of a language. In the alternative embodiment of the invention, the translation software can make use of subsets of a dictionary.

It will be realised that the multi-lingual closed captioning support provided by the invention can also be used in connection with recorded broadcast data. In one further developed embodiment of the invention, the terminal comprises, or is capable of being connected to, a player for a portable multi-media data storage means with embedded closed-captioning information stored thereon. This embodiment of the terminal is programmed to continuously form data elements from the embedded closed-captioning information stream stored on the multi-media data storage means, each data element being unique to a closed-captioning string.

The portable multi-media data storage means could be a Digital Versatile Disk (DVD), a Compact Disk (CD), a hard disk, or the like. The player can be an internal player, accessible through the EIDE-controller 23 or the I2C-controller 22, for instance. Alternatively, an external player can be attachable to the terminal, for example to a USB-port, with data being transferred through use of the USB-controller 21.

This embodiment of the invention is useful for use with CDs, which generally do not have the capacity for storing video data with a large number of captions. It is also useful for use with DVDs, which usually do comprise caption information, but only in a limited number of languages.

All embodiments of the terminal according to the invention can be advantageously provided by means of software applications, executed by the system processing unit 11. FIG. 3 shows the architecture of one widespread type of terminal, conformant to the Multimedia Home Platform (MHP) standard. At the lowest layer, the terminal comprises resources 32, which may differ from terminal to terminal, the configuration of FIG. 2 being merely an example. On top of that there is a layer of system software 32 and an application manager 33, which function as an operating system, providing a standard, well-defined Application Programmin Interface (API) to applications 34, which form the top layer. The application manager 33 can, for example, be a Java Virtual Machine, for interpreting so-called Xlets. The Xlets are applications 34 written in Java code. The invention may be implemented as one or more Xlets that, when run on a terminal with the architecture of FIG. 3, provide the terminal with the functionality described above.

It will be apparent to those skilled in the art that the invention is not limited to the above-described embodiments, which can be varied within the scope of the attached claims. For instance, the translation service server and terminal can exchange data elements and captions in a proprietary format or make use of a universal standard for data exchange.

Disclosed is a terminal for a television broadcast system with multi-lingual closed captioning support comprises a television receiver and a decoder for decoding a closed-captioning information stream. The terminal is programmed to continuously form data elements from the embedded closed-captioning information stream, each data element being unique to a closed-caption string. The terminal is connected to a network (29) comprising a translation service server (30), and is programmed to send the data elements with a specification of a desired caption language to the translation service server, and to receive captions in the desired language.

1. Terminal for a television broadcast system with multi-lingual closed captioning support, comprising a television receiver, a decoder for decoding an embedded closed-captioning information stream, which terminal is programmed to continuously form data elements from the embedded closed-captioning information stream, each data element being unique to a closed-caption string, characterised in that the terminal further comprises a bi-directional network interface (19, 20) for connection to a network (29) comprising a translation service server (27, 30), and is programmed to send the data elements with a specification of a desired caption language to the translation service server (27, 30), and to receive captions in the desired language from the translation service server (27, 30).

2. Terminal according to claim 1, wherein the terminal is further programmed to establish an end-to-end connection to the translation service server (27, 30) through which it re-directs the formed data elements and receives the captions in the desired language.

3. Terminal according to claim 2, wherein the terminal is programmed to include at least one return address, specifying a caption receiving terminal (1, 2, 31) with the formed data elements.

4. Terminal according to claim 1, wherein the specification of a desired language includes a specification of a subset of the desired caption language.

5. Terminal according to claim 1, comprising a speech synthesiser, capable of converting received captions in the desired language into an audio signal.

6. Terminal according to claim 1, comprising a display reformattor capable of adding the received captions in the desired language to a television picture received by the television receiver, wherein the terminal is programmed to use meta-data provided with the received captions in the desired language to determine the appearance of the received captions.

7. Terminal according to claim 1, programmed to add meta-data, specifying the appearance of a caption, to the formed data elements redirected to the translation service server (27, 30).

8. Terminal according to claim 1, comprising or capable of being connected to, a player for a portable multi-media data storage means with embedded closed-captioning information stored thereon, and programmed to continuously form data elements from the embedded closed-captioning information stream, each data element being unique to a closed-caption string.

9. Television broadcast system with multi-lingual closed-captioning support, comprising at least one terminal (1, 2) according to claim 1, which system further comprises a network (29) to which the terminal (1, 2) is connected through its interface (19, 20), the network (29) comprising a translation service server (27, 30) on which translation software is installed for translating text strings received from the terminal (1, 2) into a desired langauage specified by the terminal (1, 2), wherein the terminal (1, 2) is programmed to continuously form text strings from the embedded closed-captioning information stream and to re-direct the formed text strings through the network (29) to the translation service server (27, 30).

10. Television broadcast system according to claim 9, wherein the terminal (1, 2) is programmed to add a specification of a source language to the formed text strings re-directed to the translation service server (27, 30).

11. Television broadcast system with multi-lingual closed-captioning support, comprising at least one terminal (1, 2) according to claim 1, which system further comprises a network (29) to which the terminal (1, 2) is connected through its interface (19, 20), the network (29) comprising a translation service server (30) with a caption database with entries for a plurality of captions, each entry recording a caption identifier and at least one translation of a caption string, wherein the terminal (1, 2) is programmed to re-direct caption identifiers formed from the decoded closed-captioning information through the network (29) to the translation service server (30).

12. Computer program for a terminal (1, 2) comprising a television receiver, a decoder for decoding an embedded closed-captioning information stream, a bidirectional network interface (19, 20) for connection to a network (29) and a central processing unit (11), which computer program, when run on the terminal (1, 2), is capable of providing the terminal (1, 2) with the functionality of a terminal (1, 2) in a television broadcast system according to claim 9.

13. Data storage means comprising a computer program according to claim 12.
